(19) United States
(12) Patent Application Publication
(10) Pub. No.: US 2025/0232158 A1
(43) Pub. Date: Jul. 17, 2025

(54) System and Method for Automated Incident Triaging in Cloud Computing Environments using Trained Generative Artificial Intelligence Models

(71) Applicant: Microsoft Technology Licensing, LLC, Redmond, WA (US)

(72) Inventors: Ze Li, Shoreline, WA (US); Yu Kang, Shanghai (CN); Qingwei Lin, Beijing (CN); Murali Mohan Chintalapati, Bellevue, WA (US); Minghua Ma, Beijing (CN)

(21) Appl. No.: 18/414,705

(22) Filed: Jan. 17, 2024

(51) Int. Cl. G06N 3/0475; G06N 3/0455

(52) U.S. Cl. CPC G06N 3/0475; G06N 3/0455

(57) ABSTRACT

A method, computer program product, and computing system for processing an incident request using a triage engine associated with a cloud computing system. A candidate triage group generative artificial intelligence (AI) model is identified by processing the incident request. An assignment recommendation is generated from the candidate triage group generative AI model by processing the incident request using the candidate triage group generative AI model using training data associated with the respective candidate triage group. A target triage group is selected for triaging the incident request by processing the assignment recommendation from the candidate triage group generative AI model using the triage engine.

### BACKGROUND

Accurately and efficiently triaging incidents is a significant challenge for large-scale cloud computing systems. While many services have established rules for incident triage, these rules may be unable to cover all situations in a changing cloud environment. As a result, engineers often engage in time and resource consuming deliberations to refine incident-triage results until the correct assignment is reached.

### BRIEF DESCRIPTION OF THE DRAWINGS

FIG. 1 is a flow chart of one implementation of an automated triaging process;

FIGS. 2-4 are diagrammatic views of the automated triaging process; and

FIG. 5 is a diagrammatic view of computer system and an automated triaging process coupled to a distributed computing network.

Like reference symbols in the various drawings indicate like elements.

### DETAILED DESCRIPTION

Implementations of the present disclosure provide a framework of multi-agent triaging, where each “agent” builds on generative artificial intelligence (AI) models and represents a triage group or team that can “discuss” with other agents built on generative AI models for other triage groups based on their historical incidents, troubleshooting guide, and other triage group-specific documents to determine which triage group should triage a given incident request. These agents act as engineers from different teams, helping to triage incidents more rapidly and robustly but autonomously (i.e., without human intervention).

As will be described in greater detail below, the automated triaging process retrieves similar incidents to suggest the top triage groups that may be related to a new incident request. Each group has a generative artificial intelligence (AI) model that collects their respective troubleshooting guide, previous incidents, documents, and runtime information to collaboratively reason whether the incident can be triaged most effectively by that triage team. A triage engine makes the final decision to assign the incident request to the correct triage group. Conventional approaches leverage general machine learning models to aid in triage and diagnosis. However, the performance of these approaches is limited due to a lack of domain knowledge in general machine learning models from various triage teams.

Accordingly, implementations of the present disclosure describe processing an incident request using a triage engine associated with a cloud computing system. For example, an incident request includes a request to resolve an issue within the cloud computing system. In one example, this is a text-based request or question from a user describing a problem with the cloud computing system. In order to resolve the incident request, a triage group is selected. However, conventional approaches use rigid rule sets that may not include up-to-date considerations and/or are unable to address issues that concern multiple triage groups. This can also lead to issues where debate among users regarding a most effective triage group requires time and ultimately leads to an inefficient assignment of an incident request. If available, a candidate historical incident is identified from an incident database. The automated triaging process uses the candidate historical incident to identify a corresponding triage group's generative AI model. A candidate triage group generative AI model is identified by processing the incident request and the candidate historical incident. For example, the triage engine uses text from the incident request and/or the “hint” of the triage group generative AI model to identify a candidate triage group generative AI model.

An assignment recommendation is generated from the candidate triage group generative AI model by processing the incident request using the candidate triage group generative AI model using training data associated with the respective candidate triage group. For example, with a candidate triage group generative AI model selected, the candidate triage group generative AI model processes the incident request to generate a recommendation for assigning the incident request to a particular triage group. In some implementations, multiple candidate triage group generative AI models collaboratively generate a recommendation for assigning the incident request. A target triage group is selected for triaging the incident request by processing the assignment recommendation from the candidate triage group generative AI model using the triage engine.

While various tools for incident triage exist, implementations of the present disclosure implement powerful large language model agents to fully automate the triage process with a triage engine that continuously makes decisions based on input from different triage group agents, allowing for continuous updates. Additionally, domain knowledge specific to particular triage groups is easily integrated into an incident management system through triage group agents.

The details of one or more implementations are set forth in the accompanying drawings and the description below. Other features and advantages will become apparent from the description, the drawings, and the claims.

### The Automated Triaging Process:

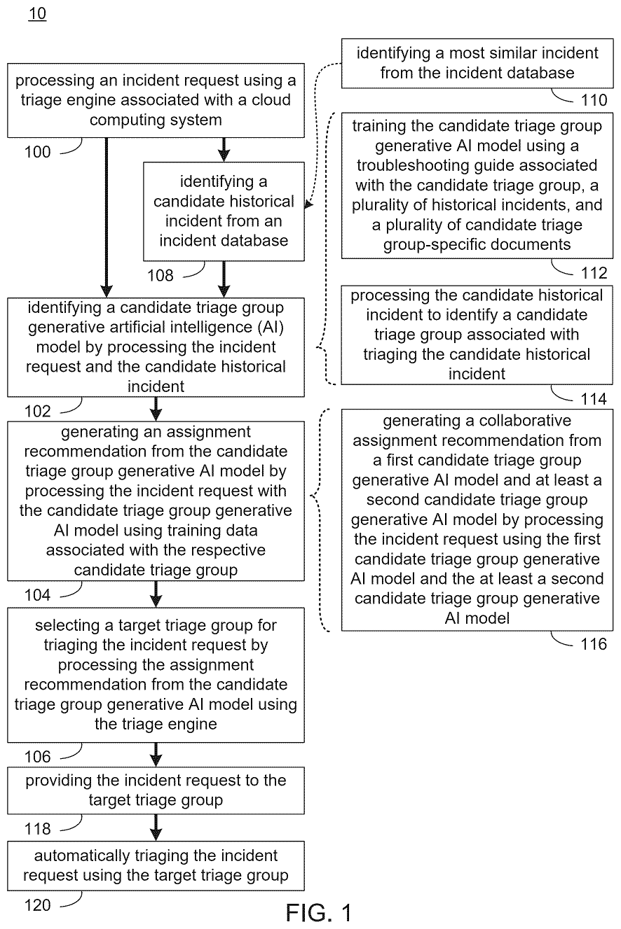

Referring to FIGS. 1-5, automated triaging process 10 processes 100 an incident request using a triage engine associated with a cloud computing system. A candidate triage group generative artificial intelligence (AI) model is identified 102 by processing the incident request. An assignment recommendation is generated 104 from the candidate triage group generative AI model by processing the incident request using the candidate triage group generative AI model using training data associated with the respective candidate triage group. A target triage group is selected 106 for triaging the incident request by processing the assignment recommendation from the candidate triage group generative AI model using the triage engine.

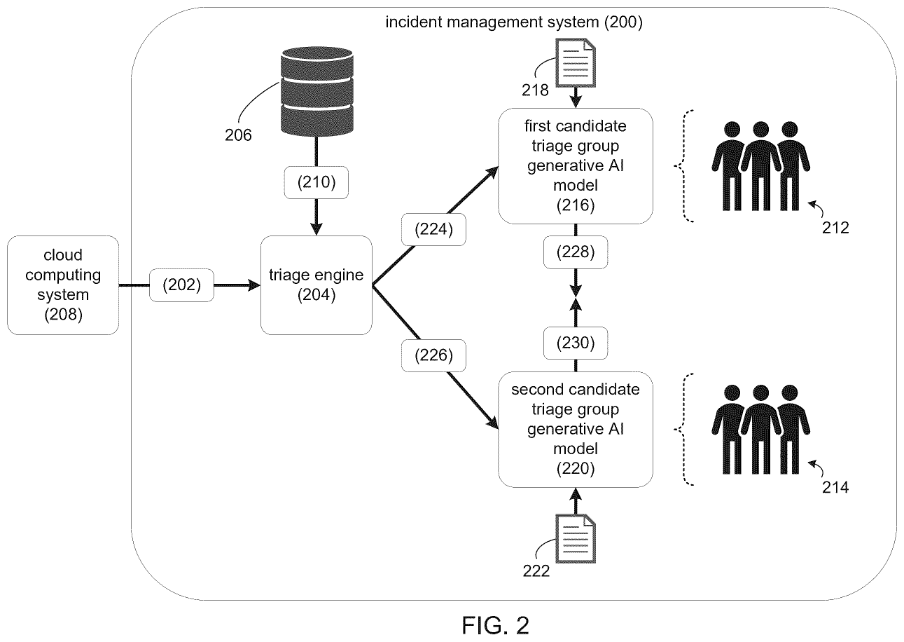

In some implementations, automated triaging process 10 processes 100 an incident request using a triage engine associated with a cloud computing system. For example, during the operation of a cloud computing system, various computing services are provided to connected users or applications. In one example, cloud computing services include storage services, processing services, and application services provided over the Internet. However, issues may occur within the cloud computing system that result in an “incident” or a detectable event that requires resolution or triaging by an incident management system. Incident management systems in a cloud computing system involve detecting, responding to, and resolving issues to ensure optimal performance and reliability. Referring also to FIG. 2, an incident management system (e.g., incident management system 200) follows a structured process (e.g., automated triaging process 10) including:
Detection: Automated tools monitor system health, performance, and security. Alerts are triggered if anomalies or issues are detected.
Alerting: The incident management system notifies relevant personnel or triage groups about the incident, providing details on the nature and severity of the problem.
Incident Triage: Triage groups prioritize incidents based on severity and potential impact, determining the appropriate response level.
Response: Triage groups initiate predefined response plans, which may include automated actions, manual interventions, or a combination to mitigate the incident.
Resolution: Once the issue is addressed, triage groups work on restoring normal system functionality. This could involve fixing code, applying patches, or scaling resources.
Post-Incident Analysis: Triage groups analyze the incident to understand its root cause and identify improvements to prevent similar issues in the future. This feedback loop contributes to ongoing system optimization.

In some implementations, incident management system 200 leverages collaborative platforms, real-time communication channels, and documentation to facilitate efficient collaboration among distributed triage groups. As will be discussed in greater detail below, automated triaging process 10 uses triage group generative AI models of an AI/LLM operating platform within the incident management system to represent the expertise of each triage group to determine whether the incident is best resolved by that particular triage group or if another triage group is better suited to handle. With automated triaging process 10 and during processing of an incident request (e.g., incident request 202), incident management system 200 processes incident request 202 with a triage engine (e.g., triage engine 204). In some implementations, triage engine 204 is a machine learning model trained to extract information from incident request 202 (e.g., incident details, affected resources, user impact, timeline of events, logs and/or traces, communication records, attempted resolution activities, etc.) to identify which triage group is best suited to triage incident request 202.

In some implementations, automated triaging process 10 identifies 108 a candidate historical incident (if available) from an incident database. For example, automated triaging process 10 has access to an incident database (e.g., incident database 206) to identify a candidate historical incident (i.e., a previous incident that was triaged by a particular triage group) that matches or most nearly matches incident request 202. In some implementations, identifying 108 the candidate historical incident includes identifying 110 a most similar incident from incident database 206. Triage engine 204 uses information extracted from incident request 202 to provide queries or search prompts to incident database 206 to identify 110 a most similar incident. In some implementations, automated triaging process 10 identifies 110 a predefined number of most similar incidents. In one example, automated triaging process 10 identifies 110 the top three similar incidents from incident database 206. In some implementations, automated triaging process 10 performs a comparison of the text produced for each incident and uses text similarity metrics/thresholds to identify the predefined number of most similar incidents.

Suppose incident request 202 concerns a storage device failure and an application failure within cloud computing system 208. In this example, triage engine 204 processes incident request 202 to identify 110 a most similar incident from incident database 206. Specifically, triage engine 204 converts incident request 202 into one or more queries to execute on incident database 206. In this example, suppose automated triaging process 10 returns candidate historical incident 210 that also concerns storage device failure with similar conditions as described in incident request 202. Suppose automated triaging process 10 returns one or more additional candidate historical incidents that concern application failures and the combination of storage device failures with application failures.

In some implementations, automated triaging process 10 identifies 102 a candidate triage group generative artificial intelligence (AI) model by processing the incident request. A candidate triage group (e.g., candidate triage groups 212, 214) is a group of resources (i.e., automated computing resources, trained machine learning models, dedicated engineers, etc.) that has access to domain knowledge in order to triage incidents. Examples of candidate triage groups include a storage triage group (e.g., a group for triaging storage issues), a processing triage group (e.g., a group for triaging processing issues), an application triage group (e.g., a group for triaging application issues), and a network triage group (e.g., a group for triaging network issues). As discussed above, conventional approaches to triaging incidents in a cloud computing system involve using predetermined rule sets and engineers to identify a target triage group to resolve an incident. However, engineers from these triage groups are tasked with determining whether their team can or should triage a particular incident. In many instances with these conventional approaches, engineers will refer the incident to another triage group. In this manner, the metric “time to resolution” includes the time lost to passing the incident between triage groups. As such, the downtime or time in which cloud computing system 208 is unavailable or subject to issues increases as the time to resolution increases.

Accordingly, automated triaging process 10 identifies 102 a candidate triage group generative artificial intelligence (AI) model (e.g., candidate triage group generative AI model 216) to automatically generate an assignment recommendation for incident request 202. For example, a generative AI model (e.g., candidate triage group generative AI model 216) is configured to receive natural language prompts and/or example entries and/or contextual information concerning an incident to generate a response (i.e., queries to better understand the incident and/or an assignment recommendation). In some implementations, the candidate triage group generative AI model includes a Large Language Model (LLM). A LLM is a language model consisting of a neural network with many parameters (typically billions of weights or more), trained on large quantities of unlabeled text using self-supervised learning or semi-supervised learning. Though trained on simple tasks along the lines of predicting the next word in a sentence, LLMs with sufficient training and parameter counts capture the syntax and semantics of human language. In addition, LLMs demonstrate considerable general knowledge and are able to “memorize” large quantities of facts during training.

In some implementations, candidate triage group generative AI model 216 is trained using domain knowledge specific to each triage group. For example, automated triaging process 10 trains 112 candidate triage group generative AI model 216 using a troubleshooting guide associated with the candidate triage group, a plurality of historical incidents, and a plurality of candidate triage group-specific documents. Referring again to FIG. 2, automated triaging process 10 trains 112 with domain knowledge (e.g., a troubleshooting guide associated with the candidate triage group, a plurality of historical incidents, and a plurality of candidate triage group-specific documents) specific to a triage group (e.g., domain knowledge 218). Returning to the above example, automated triaging process 10 trains 112 a first candidate triage group generative AI model (e.g., first candidate triage group generative AI model 216) with domain knowledge 218 concerning storage issues in cloud computing system 208. Further, automated triaging process 10 trains 112 a second candidate triage group generative AI model (e.g., second candidate triage group generative AI model 220) with domain knowledge 222 concerning application issues in cloud computing system 208. As each candidate triage group generative AI model is trained with domain knowledge specific to each triage group, the respective candidate triage group generative AI model is able to effectively determine whether incident request 202 should be assigned to the respective candidate triage group.

In some implementations, identifying 102 the candidate triage group generative AI model includes processing 114 the candidate historical incident to identify a candidate triage group associated with triaging the candidate historical incident. In one example, automated triaging process 10 uses candidate historical incident 210 to identify a candidate triage group associated with triaging historical incident 210. For example, automated triaging process 10 uses the triage group associated with candidate historical incident 210 to determine which triage group generative AI model(s) to use to generate an assignment recommendation for triage engine 204.

In some implementations, automated triaging process 10 generates 104 an assignment recommendation from the candidate triage group generative AI model by processing the incident request with the candidate triage group generative AI model using training data associated with the respective candidate triage group. For example, automated triaging process 10 provides incident request 202 to the candidate triage group generative AI model. Referring again to FIG. 2 and continuing with the example above, suppose automated triaging process 10 identifies two candidate triage groups (e.g., candidate triage groups 212, 214) for resolving incident request 202, where candidate triage group 212 is a storage triage group and candidate triage group 214 is an application triage group. Accordingly, automated triaging process 10 provides incident request 202 and/or information concerning incident request 202 to candidate triage group generative AI model 216 associated with candidate triage group 212 and to candidate triage group generative AI model 220 associated with candidate triage group 214. In this example, providing incident request 202 and/or information concerning incident request 202 to candidate triage group AI model 216 includes providing a prompt (e.g., prompt 224) with incident request 202 and/or information concerning incident request 202. Similarly, automated triaging process 10 provides prompt 226 to candidate triage group AI model 220.

In some implementations, generating the assignment recommendation includes generating a first assignment recommendation from a first candidate triage group generative AI model by processing the incident request using the first candidate triage group generative AI model using training data associated with the respective candidate triage group and generating at least a second assignment recommendation from at least a second candidate triage group generative AI model by processing the incident request using the at least a second candidate triage group generative AI model using training data associated with the respective candidate triage group. Continuing with the above example, suppose candidate triage group generative AI model 216 is trained with storage domain knowledge 218 for storage issues. In this example, triage engine 204 prompts candidate triage group generative AI model 216 with one or more prompts (e.g., prompt 224). During the prompting, candidate triage group generative AI model 216 processes prompt 224 to determine whether candidate triage group 212 can or should be assigned to resolve incident request 202.

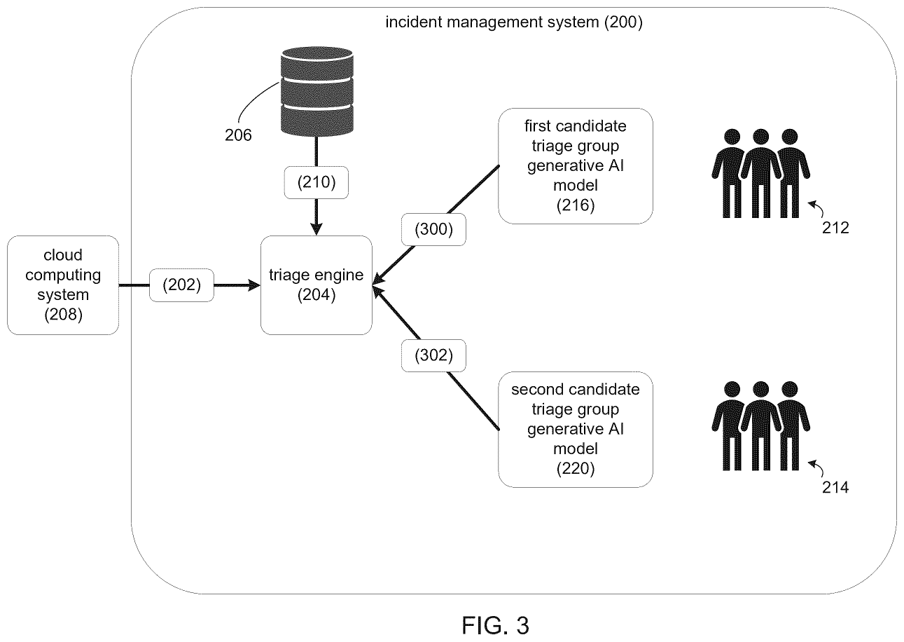

Referring also to FIG. 3 and based on the information from incident request 202 as provided in prompt 224, first candidate triage group generative AI model 216 provides an assignment recommendation (e.g., assignment recommendation 300) to triage engine 204. Similarly, second candidate triage group generative AI model 220 provides an assignment recommendation (e.g., assignment recommendation 302) to triage engine 204. In one example, assignment recommendation 300 is a numerical value ranging from a low value (e.g., “0”) to a high value (e.g., “100”). In another example, assignment recommendation 300 is a textual description of the recommendation (e.g., “recommended” or “not recommended”/“low recommendation” or “high recommendation”). In this manner and as will be discussed in greater detail below, assignment recommendation 300 is processed by triage engine 204 and used to determine which triage group is assigned to triage incident request 202.

In some implementations, generating 104 the assignment recommendation includes generating 116 a collaborative assignment recommendation from a first candidate triage group generative AI model and at least a second candidate triage group generative AI model by processing the incident request using the first candidate triage group generative AI model and the at least a second candidate triage group generative AI model, where each of the first candidate triage group generative AI model and the at least a second candidate triage group generative AI model are trained using data associated with each respective candidate triage group. Referring again to FIG. 2 and in some implementations, automated triaging process 10 provides for collaborative prompts and responses between multiple candidate triage group generative AI models. Continuing with the above example, suppose candidate triage group generative AI model 216 is associated with a storage triage group and that candidate triage group generative AI model 220 is associated with an application triage group. In this example, candidate triage group generative AI model 216 initiates a prompt (e.g., prompt 228) with candidate triage group generative AI model 220 and vice versa (e.g., with prompt 230 from candidate triage group generative AI model 220). In this manner, candidate triage group generative AI model 216 and candidate triage group generative AI model 220 generate a collaborative assignment recommendation. For example, through prompts and responses between candidate triage group generative AI models 216, 220, automated triaging process 10 is able to synergize the processing capabilities of candidate triage group generative AI models.

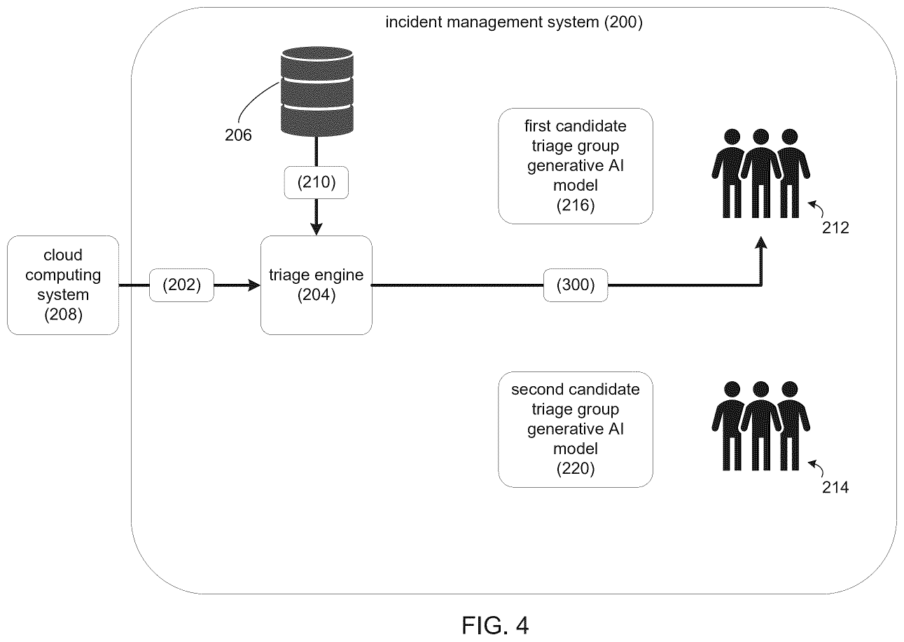

In some implementations, automated triaging process 10 selects 106 a target triage group for triaging the incident request by processing the assignment recommendation from the candidate triage group generative AI model using the triage engine. Referring also to FIG. 4, triage engine 204 processes incident request 202, candidate historical incident 210, and assignment recommendations 300, 302 to select 106 a target triage group for triaging incident request 202. Returning to the above example, suppose assignment recommendations 300, 302 indicate or recommend that triage engine 204 should assign incident request 202 to triage group 212 for triaging. In this example, triage engine 204 selects triage group 212. In some implementations, automated triaging process 10 provides 118 the incident request to the target triage group. For example and as shown in FIG. 4, automated triaging process 10 provides 118 incident request 202 to target triage group 212 for triaging.

In some implementations, automated triaging process 10 automatically triages 120 the incident request using the target triage group. As discussed above, triage group 212 includes automated systems, trained machine learning models, and/or engineers with domain knowledge. In some implementations, when assigned incident request 202, target triage group 212 automatically triages 120 incident request 202 without human intervention. For example and in some implementations, automated triaging process 10 automatically triages 120 incident request 202 using triage group generative AI model 216 and/or another machine learning model. In this manner, automated triaging process 10 is able to triage incident request 202 automatically without human or engineer intervention.

### System Overview:

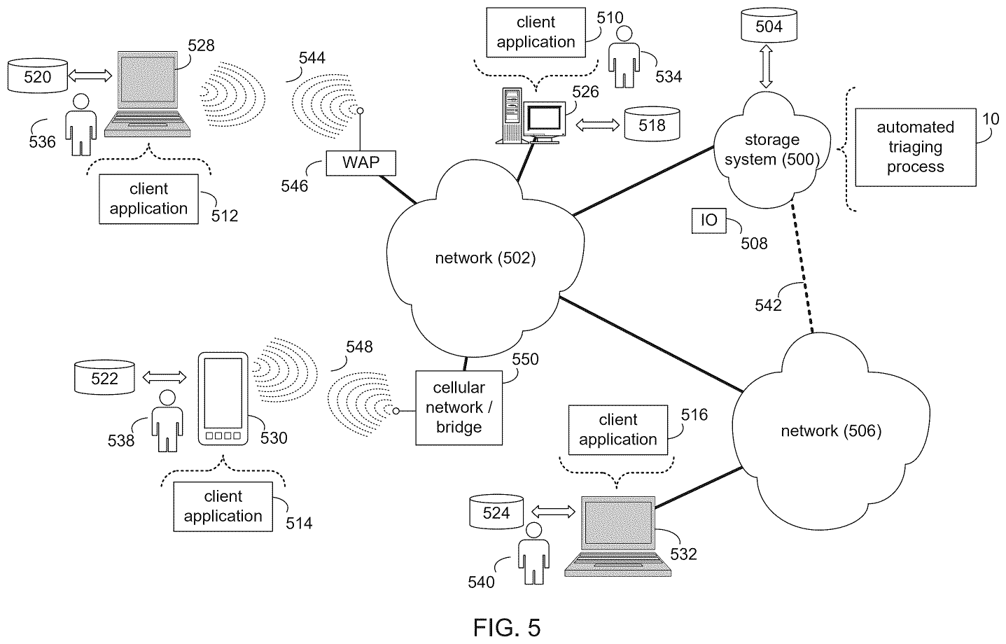

Referring to FIG. 5, an automated triaging process 10 is shown to reside on and is executed by storage system 500, which is connected to network 502 (e.g., the Internet or a local area network). Examples of storage system 500 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 500 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of automated triaging process 10, which are stored on storage device 504 included within storage system 500, are executed by one or more processors (not shown) and one or more memory architectures (not shown) included within storage system 500. Storage device 504 may include: a hard disk drive; an optical drive; a RAID device; a random-access memory (RAM); a read-only memory (ROM); and all forms of flash memory storage devices. Additionally or alternatively, some portions of the instruction sets and subroutines of automated triaging process 10 are stored on storage devices (and/or executed by processors and memory architectures) that are external to storage system 500.

In some implementations, network 502 is connected to one or more secondary networks (e.g., network 506), examples of which include: a local area network; a wide area network; or an intranet.

Various input/output (IO) requests (e.g., IO request 508) are sent from client applications 510, 512, 514, 516 to storage system 500. Examples of IO request 508 include data write requests (e.g., a request that content be written to storage system 500) and data read requests (e.g., a request that content be read from storage system 500).

The instruction sets and subroutines of client applications 510, 512, 514, 516, which may be stored on storage devices 518, 520, 522, 524 (respectively) coupled to client electronic devices 526, 528, 530, 532 (respectively), may be executed by one or more processors (not shown) and one or more memory architectures (not shown) incorporated into client electronic devices 526, 528, 530, 532 (respectively). Storage devices 518, 520, 522, 524 may include: hard disk drives; tape drives; optical drives; RAID devices; random access memories (RAM); read-only memories (ROM), and all forms of flash memory storage devices. Examples of client electronic devices 526, 528, 530, 532 include personal computer 526, laptop computer 528, smartphone 530, laptop computer 532, a server (not shown), a data-enabled, and a dedicated network device (not shown). Client electronic devices 526, 528, 530, 532 each execute an operating system.

Users 534, 536, 538, 540 may access storage system 500 directly through network 502 or through secondary network 506. Further, storage system 500 may be connected to network 502 through secondary network 506, as illustrated with link line 542.

The various client electronic devices may be directly or indirectly coupled to network 502 (or network 506). For example, personal computer 526 is shown directly coupled to network 502 via a hardwired network connection. Further, laptop computer 532 is shown directly coupled to network 506 via a hardwired network connection. Laptop computer 528 is shown wirelessly coupled to network 502 via wireless communication channel 544 established between laptop computer 528 and wireless access point (e.g., WAP) 546, which is shown directly coupled to network 502. WAP 546 may be, for example, an IEEE 802.11a, 802.11b, 802.11g, 802.11n, Wi-Fi®, and/or Bluetooth® device that is capable of establishing a wireless communication channel 544 between laptop computer 528 and WAP 546. Smartphone 530 is shown wirelessly coupled to network 502 via wireless communication channel 548 established between smartphone 530 and cellular network/bridge 550, which is shown directly coupled to network 502.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing an incident request using a triage engine associated with a cloud computing system;
identifying a candidate triage group generative artificial intelligence (AI) model by processing the incident request;
generating an assignment recommendation from the candidate triage group generative AI model by processing the incident request with the candidate triage group generative AI model using training data associated with the respective candidate triage group; and
selecting a target triage group for triaging the incident request by processing the assignment recommendation from the candidate triage group generative AI model using the triage engine.

2. The computer-implemented method of claim 1, further comprising:
providing the incident request to the target triage group; and
automatically triaging the incident request using the target triage group.

3. The computer-implemented method of claim 1, further comprising:
identifying a candidate historical incident from an incident database.

4. The computer-implemented method of claim 3, wherein identifying the candidate triage group generative AI model includes processing the candidate historical incident to identify a candidate triage group associated with triaging the candidate historical incident.

5. The computer-implemented method of claim 1, further comprising:
training the candidate triage group generative AI model using a troubleshooting guide associated with the candidate triage group, a plurality of historical incidents, and a plurality of candidate triage group-specific documents.

6. The computer-implemented method of claim 1, wherein the candidate triage group generative AI model is a large language model (LLM).

7. The computer-implemented method of claim 1, wherein generating the assignment recommendation includes generating a collaborative assignment recommendation from a first candidate triage group generative AI model and at least a second candidate triage group generative AI model by processing the incident request using the first candidate triage group generative AI model and the at least a second candidate triage group generative AI model, wherein each of the first candidate triage group generative AI model and the at least a second candidate triage group generative AI model are trained using data associated with each respective candidate triage group.

8. A computing system comprising:
a memory; and
a processor configured to process an incident request using a triage engine associated with a cloud computing system, to identify a candidate historical incident from an incident database, to identify a plurality of candidate triage group generative artificial intelligence (AI) models by processing the incident request and the candidate historical incident, to generate a first assignment recommendation from a first candidate triage group generative AI model by processing the incident request with the first candidate triage group generative AI model using training data associated with the first candidate triage group, to generate at least a second assignment recommendation from at least a second candidate triage group generative AI model by processing the incident request with the at least a second candidate triage group generative AI model using training data associated with the second candidate triage group, and to select a target triage group for triaging the incident request by processing the first assignment recommendation and the at least a second assignment recommendation using the triage engine.

9. The computing system of claim 8, wherein processor is further configured to:
provide the incident request to the target triage group; and
automatically triage the incident request using the target triage group.

10. The computing system of claim 8, wherein identifying the candidate historical incident includes identifying a most similar incident from the incident database.

11. The computing system of claim 10, wherein identifying the candidate triage group generative AI model includes processing the candidate historical incident to identify a candidate triage group associated with triaging the candidate historical incident.

12. The computing system of claim 8, wherein the processor is further configured to:
train the candidate triage group generative AI model using a troubleshooting guide associated with the candidate triage group, a plurality of historical incidents, and a plurality of candidate triage group-specific documents.

13. The computing system of claim 8, wherein the candidate triage group generative AI model is a large language model (LLM).

14. The computing system of claim 8, wherein the processor is further configured to:
generate a collaborative assignment recommendation using the first candidate triage group generative AI model and the at least a second candidate triage group generative AI model by processing the incident request using each of the first candidate triage group generative AI model and the at least a second candidate triage group generative AI model until the first candidate triage group generative AI model and the at least a second candidate triage group generative AI model recommend the same candidate triage group for triaging the incident request.

15. A computer program product residing on a non-transitory computer readable medium having a plurality of instructions stored thereon which, when executed by a processor, cause the processor to perform operations comprising:
processing an incident request using a triage engine associated with a cloud computing system;
identifying a plurality of candidate triage group generative artificial intelligence (AI) models by processing the incident request;
generating a collaborative assignment recommendation from a first candidate triage group generative AI model and at least a second candidate triage group generative AI model by processing the incident request with the first candidate triage group generative AI model and the at least a second candidate triage group using training data associated with each respective candidate triage group; and
selecting a target triage group for triaging the incident request by processing the collaborative assignment recommendation using the triage engine.

16. The computer program product of claim 15, wherein the operations further comprise:
providing the incident request to the target triage group; and
automatically triaging the incident request using the target triage group.

17. The computer program product of claim 15, wherein the operations further comprise:
identifying a plurality of most similar candidate historical incidents from an incident database.

18. The computer program product of claim 17, wherein identifying the plurality of candidate triage group generative AI models includes processing the plurality of most similar candidate historical incidents to identify a plurality of candidate triage groups associated with triaging the plurality of most similar candidate historical incidents.

19. The computer program product of claim 15, wherein the operations further comprise:
training the candidate triage group generative AI model using a troubleshooting guide associated with the candidate triage group, a plurality of historical incidents, and a plurality of candidate triage group-specific documents.

20. The computer program product of claim 15, wherein the candidate triage group generative AI model is a large language model (LLM).
